(19) United States
(12) Patent Application Publication
(10) Pub. No.: US 2010/0153835 A1
(43) Pub. Date: Jun. 17, 2010

(54) LINKING ANNOTATIONS TO DOCUMENT OBJECTS

(75) Inventors: Wuzhen Xiong, Shanghai (CN); Chuen Yan Sit, Shanghai (CN); Zicheng Li, Shanghai (CN); Xiang Ma, Shanghai (CN)

Correspondence Address: SCHWEGMAN, LUNDBERG & WOESSNER/SAP, P.O. BOX 2938, MINNEAPOLIS, MN, 55402, US

(73) Assignee: Business Objects, S.A., Levallois-Perret (FR)

(21) Appl. No.: 12/336,940

(22) Filed: Dec. 17, 2008

(51) Int. Cl. G06F 17/20

(52) U.S. Cl. 715/230

(57) ABSTRACT

In an example embodiment, a method is provided for linking an annotation to a document object of a document. Here, a structured document format associated with the document is accessed and this structured document format defines document objects and object identifiers identifying the document objects. The annotation assigned to the document object is received and an object identifier that identifies the document object is identified. This object identifier comprises at least one other document object that is related to the document object. The object identifier is then associated with the annotation and this association links the annotation to the document object.

### FIELD

The present disclosure relates generally to data presentation. In some embodiments, the disclosure relates to linking annotations to document objects.

### BACKGROUND

A typical enterprise platform provides a centralized location for users to share documents from various sources, such as word processing programs, spreadsheet applications, and presentation programs. Various types of document viewers may be used in the enterprise platform to render or display the shared documents. However, most document viewers only allow users to view the documents, but not to add or modify data. As a result, a user cannot add, for example, annotations regarding some information presented in the document, which the user may want to be displayed with the document to share with other users that view the document.

### BRIEF DESCRIPTION OF DRAWINGS

The present disclosure is illustrated by way of example and not limitation in the figures of the accompanying drawings, in which like references indicate similar elements and in which:

FIGS. 1a and 1b depict a diagram of a document, in accordance with an illustrative embodiment, with an added annotation;

FIG. 2 depicts a block diagram of a high-level multi-tiered software architecture, in accordance with an embodiment, of a system that is configured to accept annotations;

FIG. 3 depicts a flow diagram of a general overview of a method, in accordance with an embodiment, for generating object identifiers;

FIG. 4 depicts a flow diagram of a general overview of a method, in accordance with an embodiment, for linking annotations to document objects;

FIG. 5 depicts a diagram of an example of a document, in accordance with an embodiment, for illustrating the generation of object identifiers;

FIG. 6 depicts a diagram of another example of a document, in accordance with another embodiment, for illustrating the generation of object identifiers;

FIG. 7 depicts a block diagram illustrating a detailed method, in accordance with an embodiment, for linking an annotation with one or more of object identifiers in a document;

FIG. 8 depicts a flow diagram of a general overview of a method, in accordance with an embodiment, for positioning an annotation within the document;

FIGS. 9a and 9b depict a diagram of another example of a document, in accordance with an embodiment, for illustrating the positioning of an annotation;

FIG. 10 depicts a block diagram illustrating a detailed method, in accordance with an embodiment, for positioning an annotation within a document; and

FIG. 11 is a block diagram of a machine in the example form of processing system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

The embodiments described herein provide techniques for linking annotations to objects included in a document. In an example, a document is initially converted into a structured document format that defines all the document objects included in the document. As explained in more detail below, for example, an object identifier may be generated to uniquely identify each document object. A user may add an annotation for a particular document object, and the previously generated object identifier is used to link the annotation with the document object. As explained in more detail below, the link is used to position the annotation within the document.

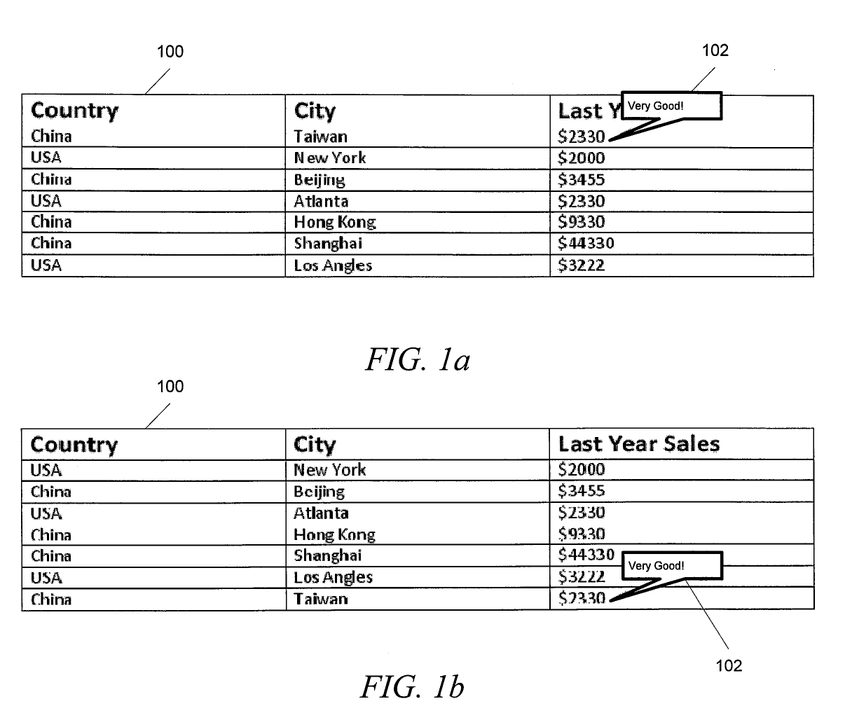

FIGS. 1a and 1b depict a diagram of a document 100 with an added annotation 102, in accordance with an illustrative embodiment. As illustrated in FIG. 1a, the document 100 includes a table comprised of rows and columns that store information regarding sales figures of various countries and cities. As used herein, a “document” refers to electronic media content that is accessible by computer technology. For example, the document 100 can be a file that is not an executable file or a system file and includes data for use by a computer program. Examples of document 100 include a single or multiple files that are accessible by and/or associated with electronic document processing applications such as word processing applications, document viewers, email applications, presentation applications, spreadsheet applications, diagraming applications, graphic editors, graphic viewers, enterprise applications, and other applications. Therefore, as explained in more detail below, the document 100 may be composed of alphanumeric text, symbols, images, videos, sounds, and other data. It should be appreciated that the document 100 can have a variety of file formats that, for example, may be identified by data within the document 100 and/or by the filename extension. Examples of file formats that may be associated with document 100 include Crystal Report (RPT) format, Microsoft DOC format, Shockwave Flash (SWF) format, Hypertext Markup Language (HTML) format, Extensible Markup Language (XML) format, Microsoft XLS format, and Tag Image File Format (TIFF).

In the example of FIG. 1a, a user adds an annotation 102 to a cell of the table with value $2330 to convey his satisfaction with the $2330 sales figure. An “annotation,” as used herein, refers to any note, comment, or other extra information that is associated with some content in the document. The annotation can be textual and/or graphical and includes, for example, alphanumeric text, graphics, hyperlinks, tables, numerical values, and highlights. In this example, the user cannot directly modify the document 100 because the document viewer that displays or renders the document 100 does not allow modifications to the document 100. Instead, as explained in more detail below, the user may use an annotation program that can add the annotation 102 to the non-modifiable document 100. The added annotation 102 is stored separately from the document 100 and is retrieved and rendered with the document 100 when the document 100 is loaded or viewed.

As illustrated in FIG. 1b, the table depicted in the document 100 may be updated where, for example, the $2330 sales figure and its associated information (e.g., country and city) are moved from the top of the table to the bottom of the table. To match the annotation 102 with the $2330 sales figure, the annotation 102 is also moved from the top of the table to the bottom of the table where the $2330 sales figure is positioned. Since the annotation 102 is stored separately from the document 100, some embodiments of the invention will establish or create a link between the $2330 sales figure and the annotation 102. As explained in more detail below, this link may be established by assigning an object identifier that identifies the particular $2330 sales figure to the annotation 102.

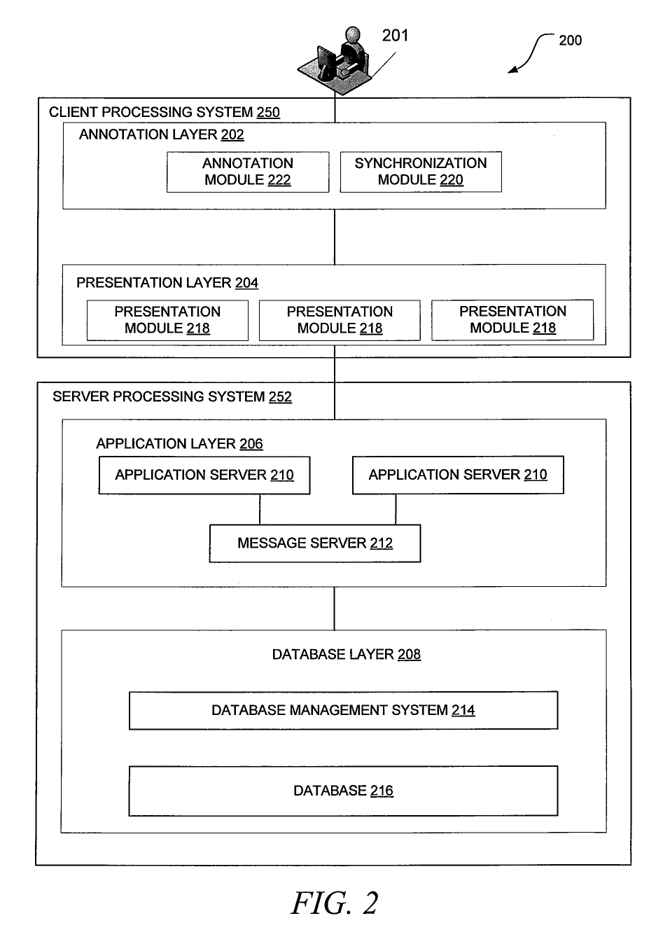

FIG. 2 depicts a block diagram of high-level multi-tiered software architecture, in accordance with an embodiment, of a system 200 that is configured to accept annotations. The system 200 illustrates a client-server database environment that includes a client processing system 250 in communication with a server processing system 252. It should be appreciated that other system topologies may be used in conjunction with other embodiments. The processing systems (e.g., client processing system 250 and server processing system 252) may be deployed in the form of a variety of computing devices, such as personal computers, laptops computers, server computers, or other computing devices. In various embodiments, the processing systems 250 and 252 may be used to implement computer programs, logic, applications, methods, processes, or software to link annotations with document objects and to position the annotations based on the links, as described in more detail below.

In the example of FIG. 2, the client processing system 250 may embody an annotation layer 202 and a presentation layer 204. In general, the presentation layer 204 provides a display of documents. One or more presentation modules 218 included in the presentation layer 204 are configured to provide a graphical interface for displaying documents received from the application layer 206 to one or more users 201. Examples of presentation modules 218 that can display documents include web browsers, document viewers (e.g., JAVA applet viewers), image viewers, and report viewers (e.g., Crystal Reports viewers and Dynamic Hypertext Markup Language (DHTML) viewers). In an example, the presentation modules 218 do not allow the user 201 to modify the document being displayed. For example, the user 201 can just simply view the document, but cannot add to or modify the content of the document. Such presentation modules 218 may not include such modification capabilities or the user 201 is not provided with the permission to modify the document.

The annotation layer 202 is a software layer in addition to the presentation layer 204 that overcomes the limitations of the presentation layer 204 by allowing the user 201 to add annotations to otherwise non-modifiable documents displayed from the presentation layer 204. As depicted in FIG. 2, the annotation layer 202 may include an annotation module 222 and a synchronization module 220. The annotation layer 202 additionally allows the user 201 to add annotations to different document types, which may be formatted in different formats, and the annotations can be added without modifying the original document. It should be noted that the document cannot be modified from the annotation layer 202 because, for example, the presentation layer 204 has limited communication with the annotation layer 202. The communication is limited because, for example, the annotation layer 202 is not configured to communicate with the presentation layer 204 at the application programming interface (API) level, which can be labor intensive to implement. In fact, the presentation layer 204 may not expose any API to the annotation layer 202.

The annotation module 222 is configured to receive and display annotations provided by the user 201. An example of an annotation module 222 is a multimedia software that creates animation in and provides interactivity to web pages. As explained in more detail below, the synchronization module 220 is configured to link annotations with document objects and to provide positions of the annotations to the annotation module 222.

The server processing system 252 may embody an application layer 206 and a database layer 208. The application layer 206 includes, for example, application servers 210 and message servers 212. Each application server 210 may, for example, provide a set of enterprise services. For example, a Crystal Management Server is a type of application server 210 that manages a Crystal Enterprise Framework and this Crystal Management Server may serve as a central enterprise repository for storing business objects and metadata. The message servers 212 are responsible for communication between the application servers 210.

The database layer 208 includes one or more database management systems (DBMS) 214 and databases 216. The databases 216 are configured to store data managed by the application servers 210. For example, the database 216 may be a Crystal Management Server database that is configured to store annotations added by the user 201. The DBMS 214 may comprise any suitable system for managing a database instance. Generally, the DBMS 214 may receive requests for data (e.g., Structured Query Language (SQL) requests), retrieve the requested data from the database 216, and return the requested data to a requestor. The DBMS 214 may also perform start-up, logging, recovery, management, optimization, monitoring, and other database-related tasks.

It should be appreciated that in other embodiments, the software layers 202, 204, 206, and 208, as embodied in client processing system 250 and/or server processing system 252, may include fewer, more, or different modules apart from those shown in FIG. 2. For example, in some embodiment, the synchronization module 220 may be integrated within the annotation module 222.

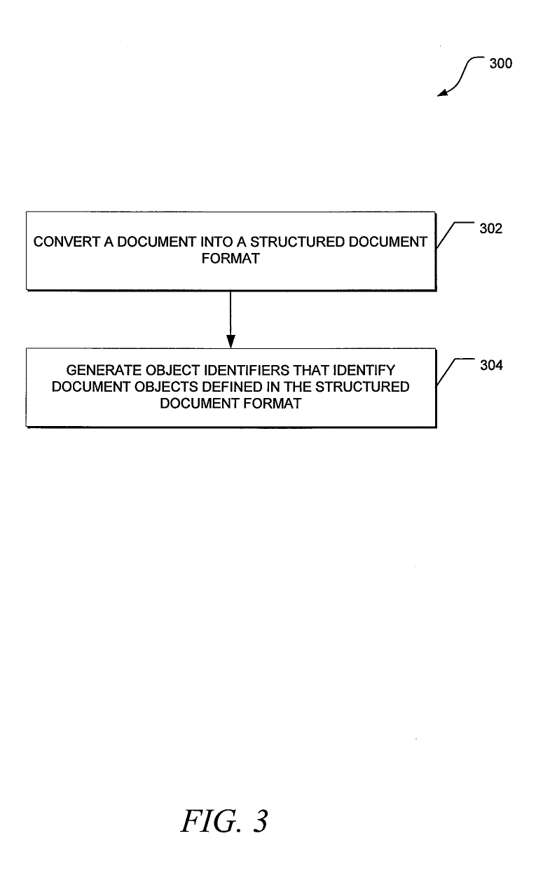

FIG. 3 depicts a flow diagram of a general overview of a method 300, in accordance with an embodiment of the invention, for generating object identifiers. In an embodiment, the method 300 may be implemented within the presentation layer 204 and employed in the client processing system 250 depicted in FIG. 2. As depicted in FIG. 3, a document is accessed and converted into a structured document format at 302. However, if the document is already in a structured document format, then the document is not converted. In an example, the document can be converted by parsing the document into the structured document format. A “structured document format,” as used herein, refers to a format for defining contents of a document as objects. In general, an “object” or “document object” refers to an element of a document, which may, for example, include alphanumeric text, numerical values, graphics, tables, hyperlinks, titles, and headings. The Extensible Markup Language (XML) and Hypertext Markup Language (HTML) formats are examples of two different structured document formats. The structured document format may also be in the form of a document object model (DOM), which is a programming API for XML and HTML documents. Examples of DOMs include HTML DOM and XML DOM.

The structured document format defines document objects and, at 304, an object identifier may be generated for one or more document objects defined in the structured document format. An “object identifier” refers to a value (numeric and/or textual) that uniquely identifies one or more document objects. The object identifier identifying a particular element is comprised of other document objects that are related to the particular element. For example, a particular document object is related to a first document object comprised of text “cup” and a second document object comprised of text “color.” An object identifier may be generated for this particular document object by appending “cup” to “color,” which generates a “cup-color” object identifier.

A document object can be related to another document object based on a variety of different logical or causal connections. For example, a document object that is a neighbor to another document object may be related. In another example, a document object can be related to another document object based on a common set of shared words. In yet another example, document objects may be related based on a hierarchical structure and therefore, the object identifiers can be generated based on the hierarchical structure. In general, a hierarchical structure is a system for ranking various document objects. An example of a hierarchical structure is a tree structure, where links branch out from one or more document objects without forming closed loops. In a document where the document objects are organized following a hierarchical structure, a document object is an ascendant (or parent) of another document object if this document object is one step or more higher in the hierarchy. On the other hand, a document object is a descendant (or child) of another document object if this document object is one step or more lower in the hierarchy. A document object is a sibling of another document object if both document objects are at the same level in the hierarchy. As a result, a document object can be related to another document object that is its ascendant, descendant, or sibling.

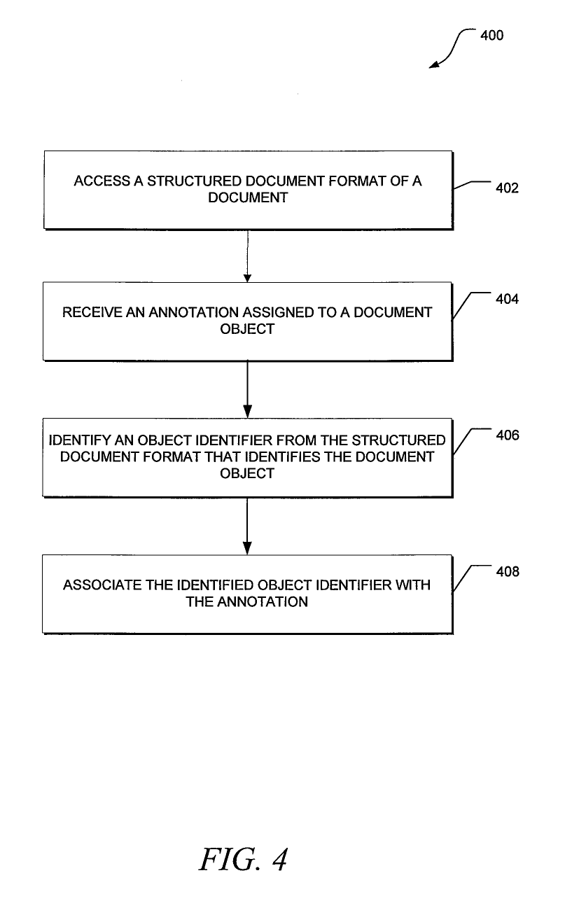

FIG. 4 depicts a flow diagram of a general overview of a method 400, in accordance with an embodiment, for linking annotations to document objects. In some embodiments, the method 400 may be implemented within the annotation layer 202 and the presentation layer 204, which may be employed in the client processing system 250 of FIG. 2. In an alternate embodiment, the method 400 may be implemented by the annotation layer 202. As depicted in FIG. 4, the structured document format of a document is accessed at 402. Additionally, an annotation assigned to a selected document object is received at 404.

The structured document format defines all the document objects and, in an embodiment, also the object identifiers associated with the document objects. As discussed above, the object identifiers are generated within the presentation layer. The object identifier that identifies the selected document object is identified from the structured document format at 406. Identification may be made by, for example, matching a position of the annotation with one of the positions of a document object defined in the structured document format, which is described in more detail below. Once the selected document object is identified from the structured document format, its corresponding object identifier can be accessed.

After the object identifier associated with the selected document object is identified, the object identifier is then associated with the annotation at 408 such that the association links the annotation to the selected document object. In an embodiment, the association of the object identifier with the annotation is stored separately from the document. That is, the association is not stored within the document. Instead, for example, the annotation may be stored with its object identifier in a Crystal Management Server database. Such association allows the annotation to be linked to a selected document object without modifying the document. As explained in more detail below, such links may then be used to later position the annotation with respect to its document object when, for example, the document object is moved.

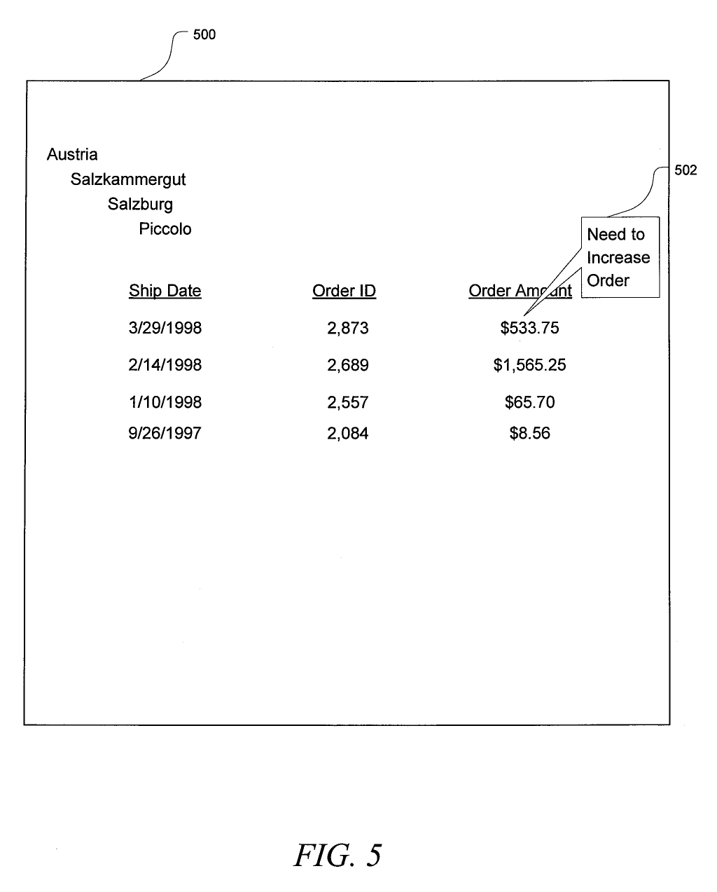

FIG. 5 depicts a diagram of an example of a document 500, in accordance with an embodiment, for illustrating the generation of object identifiers. This document 500 includes various document objects, such as Austria, ship date, order identification, and order amount, and an object identifier may be generated for one or more document objects. In the example of FIG. 5, some document objects included in the document 500 are organized following a hierarchical structure. As depicted, the order information follows a hierarchical structure where the country of “Austria” is an ascendant of the region of “Salzkammergut” and the region of “Salzkammergut” is an ascendant of the city of “Salzburg,” which is also an ascendant of a customer “Piccolo.” The various ship dates, order identifications, and order amounts are descendants of the customer “Piccolo.”

In this example, a user adds an annotation 502 to the order amount document object “$533.75” conveying a message that the order needs to be increased. An object identifier is generated for this particular “$533.75” document object based on appending or combining related document objects. For example, the object identifier may be generated based on the hierarchal relationship or structure of the document objects. The object identifier “Austria-Salzkammergut-Salzburg-Piccolo-2873-Order Amount” is an example of such a combination where the document objects “Austria,” “Salzkammergut,” “Salzburg,” and “Piccolo” are ascendants of the “$533.75” document object. It should be noted that the “order amount” document object is used in place of the “$533.75” document object because the value “$533.75” may change. By including the “order amount” document object in the object identifier, the annotation 502 will be linked to a cell in the “order amount” column that is associated with the “2,873” document object regardless of the change in value of this particular cell. The order of the ascendant document objects as defined in the object identifier may follow the hierarchal structure.

The generated object identifier is then associated with the annotation 502 and, in an example, the association may be stored in an XML format, which is defined in the following Table A.

TABLE A

```
<shape>
    <type> callout box </type>
    <annotation> Need to Increase Order </annotation>
    <objectID> Austria- Salzkammergut- Salzburg - Piccolo - 2873 -
Order Amount </objectID>
</shape>
```

In Table A, the nesting of the object identifier (or <objectID> Austria-Salzkammergut-Salzburg-Piccolo-2873-Order Amount </objectID>) and the annotation 502 (or <annotation> Need to Increase Order </annotation>) within the <shape> and </shape> document objects identifies the association of the object identifier with the annotation 502.

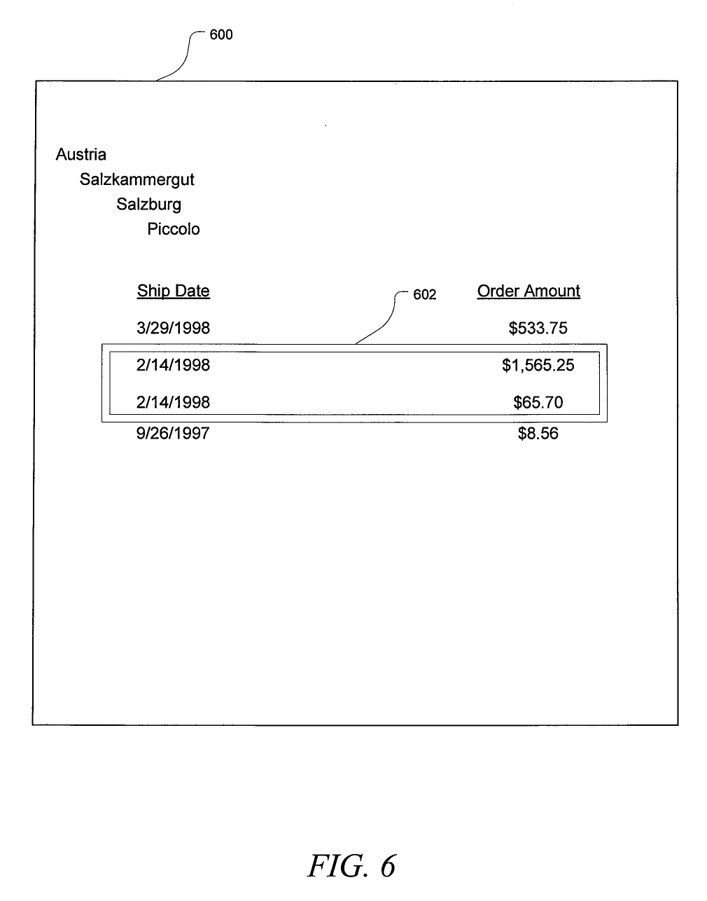

FIG. 6 depicts a diagram of another example of a document 600, in accordance with an embodiment, for illustrating the generation of object identifiers. Similar to the previously depicted example of a document, this document 600 includes various document objects, such as Austria, Piccolo, ship date, and order amount, and an object identifier may be generated for one or more document objects. As depicted, some document objects included in the document 600 are organized following a hierarchical structure where, for example, the country of “Austria” is an ascendant of the region of “Salzkammergut,” the region of “Salzkammergut” is an ascendant of the city of “Salzburg,” and the city of “Salzburg” is an ascendant of a customer “Piccolo.” The various ship dates and order amounts are descendants of the customer “Piccolo.”

In this example, a user adds an annotation 602 in the form of a rectangular border that highlights the “Feb. 14, 1998” ship date and its corresponding “$1565.25” and “$65.70” order amounts. An object identifier can be generated for these document objects based on a combination of other related document objects. For example, this object identifier may be generated based on, in part, the hierarchal structure of the document objects. The object identifier “Austria-Salzkammergut-Salzburg -Piccolo-Feb. 14, 1998-Order Amount,” for example, may be used to identify all the order amount document objects that are associated with the “Feb. 14, 1998” document object. On the other hand, if each cell is to be identified separately, then the numerical order amounts is used or included in object identifiers rather than the column/field header (or “Order Amount”). For example, the object identifier for the “$65.70” order amount can be “Austria-Salzkammergut-Salzburg-Piccolo-Feb. 14, 1998-$65.70.”

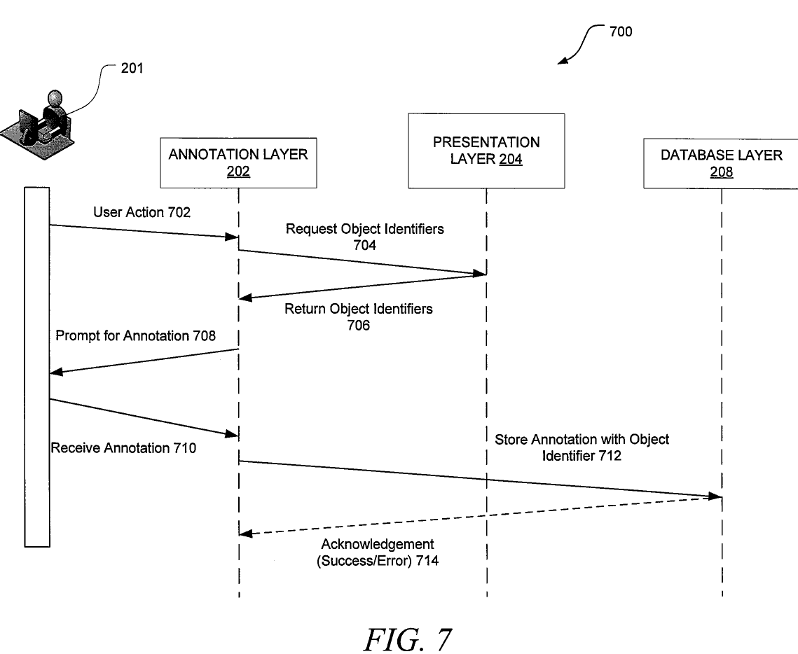

FIG. 7 depicts a block diagram illustrating a detailed method 700, in accordance with an embodiment, for linking an annotation with one or more object identifiers in a document. A user 201 initiates an action at 702 by, for example, clicking at a position (e.g., X and Y coordinate) to add an annotation regarding a particular document object. In turn, the annotation layer 202 may use an external interface call to pass a request for an object identifier at 704 to the presentation layer 204. The request may include the position inputted by the user 201 or other identifiers that may be used to identify document objects.

The presentation layer 204 accesses a document and converts the document into a structured document format, which defines all the document objects and their respective positions within the document. In an embodiment, from this structured document format, the presentation layer 204 may generate an object identifier for each document object. In an embodiment, the presentation layer 204 generates object identifiers that are requested by the annotation layer 202. In the example of FIG. 7, the presentation layer 204 identifies the document object associated with the annotation by, for example, matching the received position with one of the positions defined in the structured document format. If a match in position is found, the presentation layer 204 identifies the document object associated with the match and retrieves or generates an object identifier for this identified document object. In an embodiment, as discussed above, the object identifier may be generated by identifying at least one ascendant document object following a hierarchical structure and appending this ascendant document object to other related document objects. The presentation layer 204 then exposes or transmits this generated object identifier at 706 to the annotation layer 202.

With receipt of the object identifier, the annotation layer 202 may prompt the user 201 for an annotation at 708. In response to the prompt, the annotation layer 202 receives the annotation at 710 from the user 201 and associates the received object identifier with the annotation in order to link the annotation with the selected document object. At 712, the annotation layer 202 then stores the annotation with its object identifier in, for example, a Crystal Management Server database that is located in the database layer 208. The annotation layer 202 may receive an acknowledgment at 714 from the database layer 208 on whether the storage operation was successful or in error.

In an alternate embodiment, a relative position of the annotation may also be stored with the annotation and the object identifier. A “relative position” (or a position relative to) as used herein, is a position that is related to or made in reference to a position of the document object, which is defined in the structured document format. The relative position is calculated based on a difference between the position of annotation as received from (or designated by) the user 201 and the position of the document object as defined in the structured document format. For example, if a position of the annotation is located along horizontal axis X=8 and a position of the associated document object is located along horizontal axis X=10, then the relative position of the annotation is a difference between the two positions, which is 10−8=2 along the horizontal axis. In an alternate embodiment, this relative position can also be associated with the object identifier and stored with the annotation and the object identifier. As a result of storing the relative position, and if the document object is subsequently placed in a different position within the document, the stored relative position allows the annotation to be positioned at the same place as the user originally designated relative to the position of the document object.

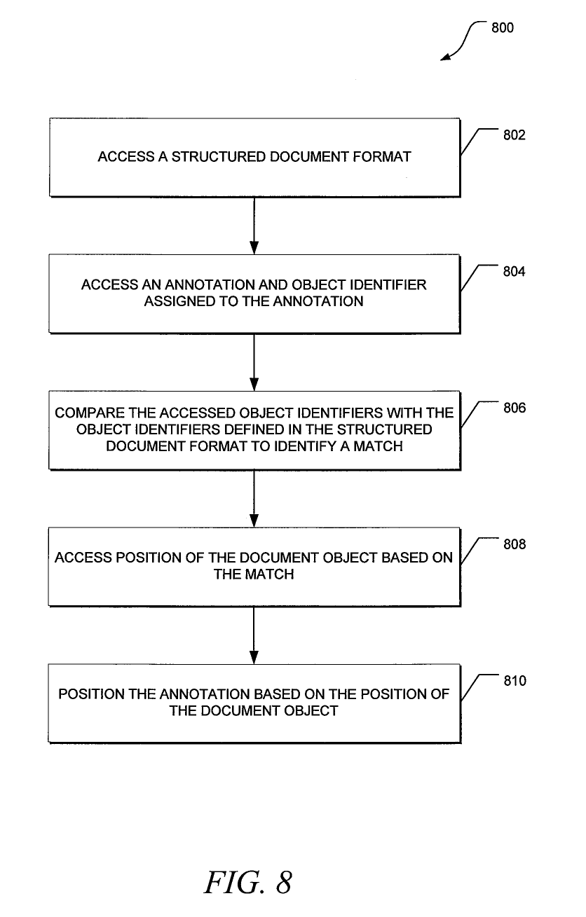

FIG. 8 depicts a flow diagram of a general overview of a method 800, in accordance with an embodiment, for positioning an annotation within the document. In an embodiment, the method 800 may be implemented within the annotation layer 202 and employed in the client processing system 250 depicted in FIG. 2. As depicted in FIG. 8, the structured document format is accessed at 802, and this structured document format defines document objects, object identifiers identifying document objects, and positions of the document objects within the document.

An annotation and an object identifier assigned to the annotation are accessed at 804 from, for example, a Crystal Management Server database. The object identifier is then compared with at least one of the object identifiers defined in the structure document format at 806 to identify a match. If a match is found, the position associated with the matched object identifier is accessed at 808 from the structured document format and the annotation is then positioned based on this accessed position at 810.

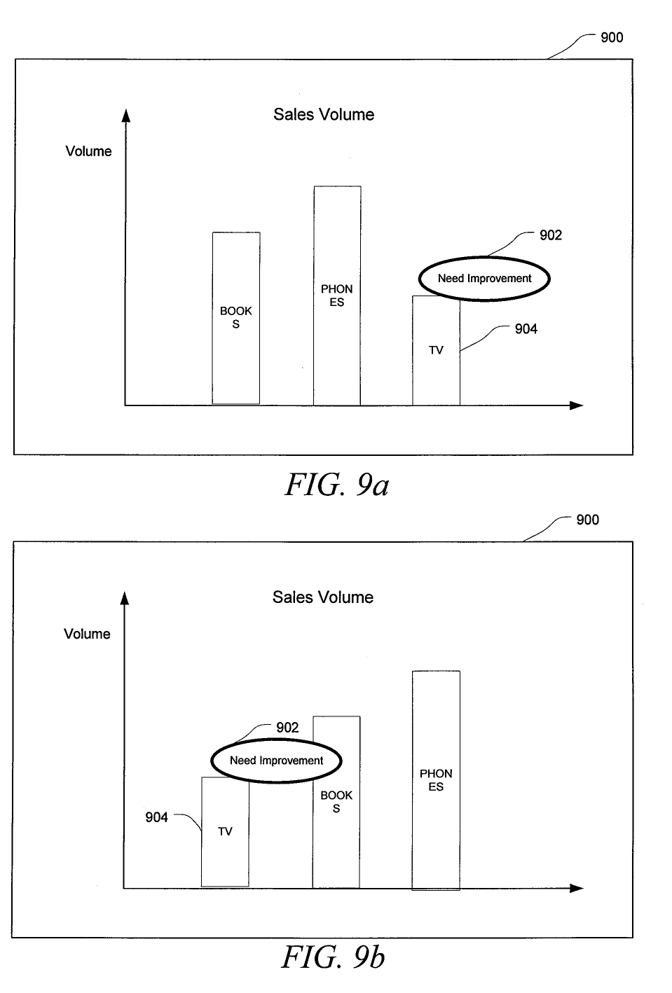

FIGS. 9a and 9b depict a diagram of another example of a document 900, in accordance with an embodiment, for illustrating the positioning of an annotation 902. As illustrated in FIG. 9a, this document 900 depicts a bar chart and includes various document objects in the form of rectangular bars (e.g., bar document object 904) with each rectangular bar defining a particular volume. The document 900 is accessed and converted into a structured document format that defines document objects (e.g., bar document object 904) and positions of the document objects. An object identifier may then be generated for each document object.

In this example, an annotation 902 and its object identifier are accessed from, for example, a database layer and the accessed object identifier is compared with the object identifiers defined in the structured document format to identify a match. When a match is identified, the position associated with the matched object identifier as defined in the structured document format is accessed and the annotation 902 is positioned based on this accessed position.

FIG. 9b illustrates the same document 900 with the same document objects but, in this example, the bar document object 904 has been moved from the right end of the chart to the left end of the same chart. The position of the bar document object 904 has changed and this change is reflected or updated in the structured document format when the document is refreshed. The document 900 can be refreshed when, for example, an annotation module rereads or reloads the structured document format, which may occur at regular intervals and upon loading of the document 900. Since the position of the bar document object 904 has changed, the position of the annotation 902 is also repositioned such that the annotation 902 is also moved from the right end of the chart to the left end of the same chart. In an embodiment, if the relative position of the annotation 902 is also stored and accessed, the annotation 902 may be repositioned based on a position of the bar document object 904 and the relative position of the annotation 902.

It should be noted that the document 900 may be in the form of a dynamic chart or a multimedia file that cannot be converted into a structured document format. With these types of documents, their document objects may also be associated with annotations, in accordance with an alternate embodiment. Even though these documents cannot be converted into a structured document format, they may include information regarding each document object. In FIG. 9a, for example, the document 900 may define the “TV” rectangular bar as a document object 904. An object identifier may be generated for this object 904 based on, for example, the name of the object 904, which is “TV,” or other information included in the document 900, such as a title of the chart (e.g., “Sales Volume”) or other information. Such object identifiers may be shown to a user, for example, in a list such that the user can specify a particular document object to be associated with his annotation. The object identifier is then associated with the annotation 902 and, in an example, the association may be stored in an XML format, which is defined in the following Table B.

TABLE B

```
<shape>
    <type> Chart </type>
    <objectID> ######Sales Volume </objectID>
    <sub object>
        <type> SeriesBar <type>
        <annotation> Need Improvement <annotation>
        <objectID> TV <objectID>
        <RelativeCenterPosX>12<RelativeCenterPosX>
        <RelativeCenterPosY>134<RelativeCenterPosY>
    <sub object>
</shape>
```

The sub document object (or <sub object>), as defined in Table B, is a document object that is subordinate to another document object. It should be noted that special “######” characters may be associated with a particular object identifier to identify that the document object associated with this object identifier cannot be converted into a structured document format. As also defined in Table B, a relative position is also stored with the annotation and its object identifier.

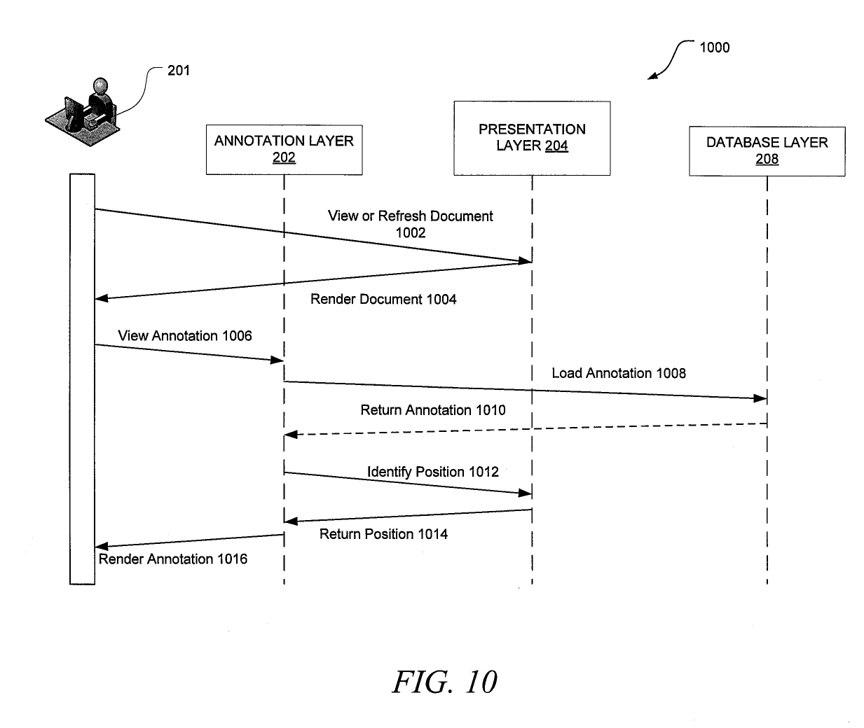

FIG. 10 depicts a block diagram illustrating a detailed method 1000, in accordance with an embodiment, for positioning an annotation within a document. In response to a view or refresh event at 1002, the presentation layer 204 renders a document at 1004. The user 201 makes a request at 1006 to view the annotations associated with the document and, in turn, the annotation layer 202 accesses the annotations and their object identifiers at 1008 and 1010 from the database layer 208. The annotation layer 202 then transmits requests at 1012 for positions associated with the annotations to the presentation layer 204 and, in response, the presentation layer 204 compares the object identifiers included in the request with the object identifiers defined in the structured document format to identify matches between the object identifiers. The annotation layer 202 then retrieves the positions of the document objects defined in the structured document format based on the matches and transmits a response at 1014 to the annotation layer 202 with the positions. Upon receipt of the positions, the annotation layer 202 renders the annotations 1016 and positions the annotations based on the positions and, in an alternate embodiment, relative positions if provided.

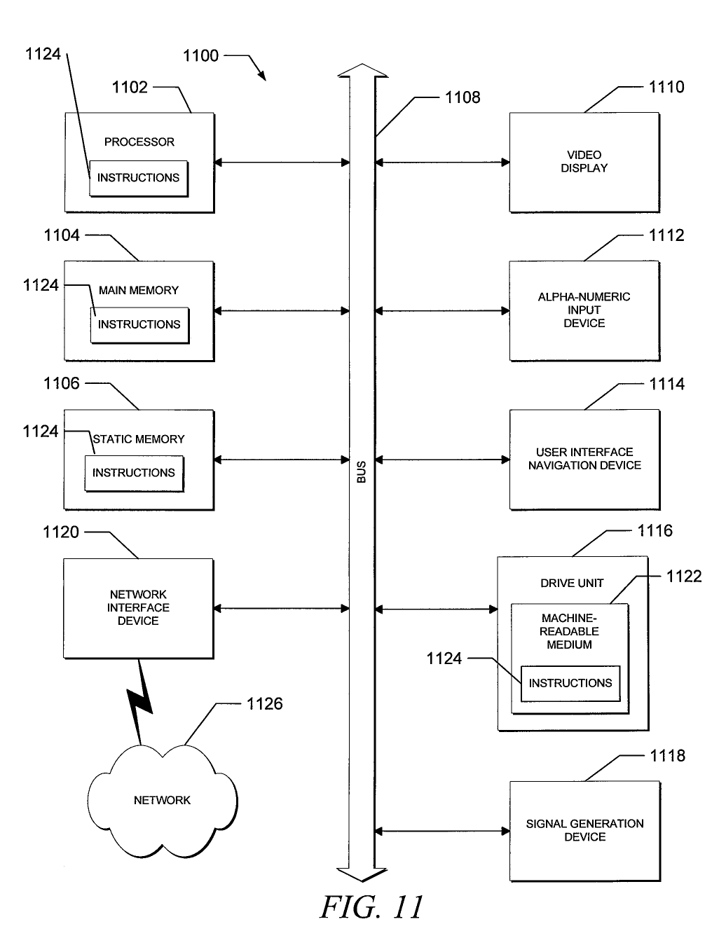

FIG. 11 is a block diagram of a machine in the example form of a processing system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. Embodiments may also, for example, be deployed by Software-as-a-Service (SaaS), Application Service Provider (ASP), or utility computing providers, in addition to being sold or licensed via traditional channels.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example processing system 1100 includes a processor 1102 (e.g., a central processing unit (CPU), a graphics processing unit (GPU) or both), a main memory 1104, and static memory 1106, which communicate with each other via bus 1108. The processing system 1100 may further include video display unit 1110 (e.g., a plasma display, a liquid crystal display (LCD) or a cathode ray tube (CRT)). The processing system 1100 also includes an alphanumeric input device 1112 (e.g., a keyboard), a user interface (UI) navigation device 1114 (e.g., a mouse), a disk drive unit 1116, signal generation device 1118 (e.g., a speaker), and network interface device 1120.

The disk drive unit 1116 includes machine-readable medium 1122 on which is stored one or more sets of instructions and data structures (e.g., software 1124) embodying or utilized by any one or more of the methodologies or functions described herein. The software 1124 may also reside, completely or at least partially, within main memory 1104 and/or within processor 1102 during execution thereof by processing system 1100, main memory 1104, and processor 1102 also constituting machine-readable, tangible media.

Software 1124 may further be transmitted or received over network 1126 via network interface device 1120 utilizing any one of a number of well-known transfer protocols (e.g., HTTP).

While the invention(s) is (are) described with reference to various implementations and exploitations, it will be understood that these embodiments are illustrative and that the scope of the invention(s) is not limited to them. In general, techniques for liking and positioning annotations may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate-components. These and other variations, modifications, additions, and improvements fall within the scope of the invention(s).

What is claimed is:

1. A method of linking an annotation to a document object associated with a document, the method comprising:
accessing a structured document format associated with the document, the structured document format defining a plurality of document objects and a plurality of object identifiers identifying the plurality of document objects;
receiving the annotation assigned to the document object in the plurality of document objects;
identifying an object identifier in the plurality of object identifiers that identifies the document object, the object identifier comprising at least one of the plurality of document objects that is related to the document object; and
associating the object identifier with the annotation, the association linking the annotation to the document object.

2. The method of claim 1, further comprising storing the annotation with the object identifier.

3. The method of claim 1, wherein the structured document format further defines a first position associated with the document object, the method further comprising:
calculating a second position of the annotation that is relative to the first position; and
associating the second position with the object identifier.

4. The method of claim 3, further comprising storing the second position with the annotation and the object identifier.

5. The method of claim 1, wherein the structured document format is a document object model.

6. The method of claim 1, wherein the plurality of document objects is organized following a hierarchical structure, and wherein the at least one of the plurality of document objects is an ascendant of the document object.

7. The method of claim 1, wherein the at least one of the plurality of document objects that is related to the document object is text.

8. The method of claim 1, wherein the at least one of the plurality of document objects that is related to the document object is a numerical value.

9. The method of claim 1, wherein the structured document format is accessed from a presentation module, the presentation module configured to render at least a portion of the plurality of document objects.

10. The method of claim 1, wherein the document cannot be modified from the presentation module.

11. A processing system comprising:
at least one processor; and
a memory in communication with the at least one processor, the memory being configured to store a presentation module and a synchronization module that are executable by the at least one processor,
the presentation module having instructions, that when executed by the at least one processor, cause operations to be performed, comprising:
accessing a document;
converting the document into a document object model, the document object model defining a plurality of document objects; and
generating an object identifier identifying at least one of the plurality of document objects, the object identifier comprising at least another one of
the plurality of document objects that is an ascendant of the at least one of
the plurality of document objects associated with the object identifier,
the synchronization module having instructions, that when executed by the at least one processor, cause operations to be performed, comprising:
receiving an annotation assigned to the at least one of the plurality of document objects; and
associating the object identifier with the annotation.

12. The processing system of claim 11, wherein the operation of generating the plurality of document objects comprises:
identifying the at least another one of the plurality of document objects that is the ascendant of the at least one of the plurality of document objects; and
appending the at least another one of the plurality of document objects to the object identifier.

13. The processing system of claim 11, wherein the synchronization module having instructions, that when executed by the at least one processor, cause operations to be performed, further comprising:
receiving a relative position of the annotation, the relative position being relative to a position of the at least one of the plurality of document objects; and
associating the relative position with the object identifier.

14. The processing system of claim 11, wherein the memory is configured to store an annotation module that is executable by the at least one processor, wherein the presentation module does not expose an application programming interface to the annotation module.

15. The processing system of claim 11, wherein the presentation module is a document viewer.

16. The processing system of claim 11, wherein the document cannot be modified from the annotation module.

17. The processing system of claim 11, wherein the document object model is a HyperText Markup Language (HTML) document object model.

18. The processing system of claim 11, wherein the document object model is an Extensible Markup Language (XML) document object model.

19. A method of positioning an annotation associated with a document object, the method comprising:
accessing a structured document format associated with a document, the structured document format defining a plurality of document objects, a plurality of object identifiers identifying the plurality of document objects, and a plurality of positions of the plurality of document objects in the document;
accessing the annotation and an object identifier assigned to the annotation;
comparing the object identifier with at least one of the plurality of object identifiers defined in the structured document format to identify a match of the object identifier with the at least one of the plurality of object identifiers;
accessing a position of the document object in the plurality of document objects based on the match; and
positioning the annotation based on the position of the document object.

20. The method of claim 19, further comprising updating the positioning of the annotation based on a refresh of the document.

21. The method of claim 19, further comprising repositioning the annotation based on a change in the position of the document object.

22. The method of claim 19, wherein the object identifier comprises at least another one of the plurality of document objects that is related to the document object.

23. The method of claim 19, further comprising accessing a relative position of the annotation, the relative position being relative to the position of the document object, wherein the positioning of the annotation is further based on the relative position.

24. A machine-readable medium that stores instructions, which when performed by a machine, cause the machine to perform operations comprising:
accessing a document;
converting the document into a document object model, the document object model comprising a plurality of document objects;
identifying at least one of the plurality of document objects associated with an annotation added to the document;
identifying at least another one of the plurality of document objects that is an ascendant of the at least one of the plurality of document objects; and
generating an object identifier identifying the at least one of the plurality of document objects based on the at least another one of the plurality of document objects, the object identifier configured to be associated with the annotation.
